(19) United States
(12) Patent Application Publication
(10) Pub. No.: US 2009/0229369 A1
(43) Pub. Date: Sep. 17, 2009

(54) Capacitor Compensation Structure and Method for a Micro-Electro-Mechanical System

(76) Inventor: Siew-Seong Tan, Hsinchu City (TW)

Correspondence Address: Dr. BANGER SHIA, 102 Lindencrest Ct., Sugar Land, TX, 77479-5201, US

(21) Appl. No.: 12/049,538

(22) Filed: Mar. 17, 2008

(51) Int. Cl. G01B 7/16

(52) U.S. Cl. 73/780

(57) ABSTRACT

A capacitor compensation structure and method for a micro-electro-mechanical system, an insulating layer is formed on an upper surface of a silicon substrate, and a capacitor having at least one basic capacitive plate and one compensation capacitive plate is provided in the insulating layer. The basic capacitive plate and the compensation capacitive plate are independent from each other, each of the basic and compensation capacitive plates has a metallic circuit connected to outside, and the metallic circuits are connected to a switch. Thereby, the problem of mismatching of the capacitor can be efficiently avoided, and the difference between the products of different lots can be reduced.

### BACKGROUND OF THE INVENTION

1. Field of the Invention

The present invention relates to a capacitor compensation design, and more particularly to a brand new capacitor compensation structure and method for a micro-electro-mechanical system which can efficiently avoid the problem of mismatching of the capacitor and can reduce the process variation between the products of different lots.

2. Description of the Prior Art

Currently, semiconductor micro-electro-mechanical system includes different kinds of semiconductor micro structures, such as unmovable probe, passage, pore, or movable spring, connecting rod and gear (rigid movement or flexible deformation).

By combining the above-mentioned different structures and the related semiconductor circuits, different kinds of semiconductor applications can be formed. To improve different functions of the micro-electro-mechanical structure by using the manufacturing method is a main target of the semiconductor micro-electro-mechanical system and is a rigorous challenge in further research of the chip in the future. If the conventional technology can be improved, the development of the semiconductor micro-electro-mechanical system will be unpredictable and invaluable.

At present, micro-electro-mechanical sensor and actuator are usually provided with a capacitor, and the characteristic of the capacitor in the micro chip is used to meet different requirements of the micro-electro-mechanical system, such as the micro-electro-mechanical system microphone for transforming sound pressure into capacitance variation, the technologies of manufacturing capacitive switch and ultra thin capacitive micro sensor.

However, the conventional technology of manufacturing the micro-electro-mechanical system has to deposit a circuit layout on a silicon substrate firstly, and then an etching technology is usually performed, as a result, the following problems are produced:

Firstly, the technology of the micro-electro-mechanical system usually includes the etching process, such as wet etching, dry etching and sacrificial layer removal. Although the etching technology is a quick and efficient process, as far as the capacitor design is concerned, the biggest problem during the etching process is that the consistency of etching is unable to control precisely, such a consistency of etching will largely influence the matching of the capacitor design in the micro-electro-mechanical system.

Secondly, the circuit layout in the micro-electro-mechanical system is manufactured by using deposition or exposure and development, but such a deposition or exposure and development cannot ensure the distance consistency between the first side capacitor plate and the second side capacitive plates of the capacitor. As a result, a slight difference is likely to be produced, and even the matching of the capacitor design in the micro-electro-mechanical system will be influenced.

Referring to FIG. 1, a conventional technology is shown, a micro-electro-mechanical structure 11 is formed on a silicon substrate 10, and a capacitor 12 having a first side capacitive plate 121 and a second side capacitive plate 122 is provided in the micro-electro-mechanical structure 11. The area of the first side capacitive plate 121 is A, the area of the second side capacitive plate 122 is A, and a predetermined distance d is formed between the first and second side capacitive plates 121, 122. The capacitance satisfies the relation:

C=ε×A/d.

C represents the capacitance, and ε represents the dielectric constant.

The areas A of the first and second side capacitive plates 121, 122 must be precise and consistent, and the distance d (or the thickness of a dielectric layer) between the first and second side capacitive plates 121, 122 must also be precise, or else, the problem of mismatching of the capacitor (different from the predetermined value) will be produced, and the yield of good products of different lots or the same lot will be reduced.

Since the technologies of deposition, exposure and development cannot control such a slight difference completely, as a result, the area of the first side capacitive plate 121 is usually unequal to that of the second side capacitive plate 122, or an excessive inconsistency of the distance d between the first and second side capacitive plates 121, 122 might occur. Therefore, such a conventional capacitor still needs to be improved.

Referring to FIG. 2, another conventional technology of manufacturing a suspension micro-electro-mechanical structure is shown, a micro-electro-mechanical capacitor 12 having the first side capacitive plate 121 and the second side capacitive plate 122 is formed on the silicon substrate 10. The area of the first side capacitive plate 121 is A, and the area of the second side capacitive plate 122 is A. The predetermined distance d is formed between the first and second side capacitive plates 121, 122, and a suspension space B is formed between the first and second side capacitive plates 121, 122 by using the etching technology. The capacitance also satisfies the relation: C=ε×A/d.

C represents the capacitance, and ε represents the dielectric constant.

The areas A of the first and second side capacitive plates 121, 122 must be precise and consistent, and the distance d (or the thickness of the dielectric layer) between the first and second side capacitive plates 121, 122 must also be precise, or else, the problem of mismatching of the capacitor (different from the predetermined value) will be produced, and the yield of good products of different lots or the same lot will be reduced. Since the technologies of deposition, exposure and development cannot control such a slight difference completely, as a result, the area of the first side capacitive plate 121 is usually unequal to that of the second side capacitive plate 122, or an excessive inconsistency of the distance d between the first and second side capacitive plates 121, 122 might occur. Therefore, such a conventional capacitor still needs to be improved.

It is more important that the second conventional technology will have the problem as shown in FIG. 3 after the suspension space B of the suspension micro-electro-mechanical structure is formed. Since the first and second side capacitive plates 121, 122 are not connected with each other, the suspension space B will release the upper suspension part (including the second side capacitive plate 122), and such a part will cause the warp of the structure due to the influence of the residual stress, as a result, another distance D will appear between the first and second side capacitive plates 121, 122. Thereby, the distance d between the first and second side capacitive plates 121, 122 becomes d+D. At this moment, the real capacitance satisfies the relation:

C=ε×A/(d+D).

Moreover, there will be a bigger difference between the above-mentioned capacitance and the capacitance obtained by the relation: C=ε×A/d. Therefore, such a conventional capacitor still needs to be improved.

The present invention has arisen to mitigate and/or obviate the afore-described disadvantages.

### SUMMARY OF THE INVENTION

The primary objective of the present invention is to provide a capacitor compensation structure and method for a micro-electro-mechanical system which can efficiently compensate the condition of influencing the capacitance, improve the yield of good products and matching.

To achieve the objective of the present invention, an insulating layer is formed on an upper surface of a silicon substrate, and a capacitor is provided in the insulating layer. One side of the capacitor includes at least one basic capacitive plate and one compensation capacitive plate, and the other side of the capacitor includes an integrated capacitive plate. The above-mentioned basic capacitive plate, the compensation capacitive plate and the integrated capacitive plate are independent from one another, each of the basic, compensation and integrated capacitive plates has a metallic circuit connected to outside.

Thereby, according to the requirements, the present invention can turn on and off the compensation capacitive plate at any moment, such that the area of the integrated capacitive plate can be improved corresponding to that of the capacitive plates (the basic capacitive plate and the compensation capacitive plate), so as to adjust the capacitance slightly, such that the problem of mismatching of the capacitor can be avoided and the difference between the products of different lots can be reduced.

It is to be noted that the above-mentioned at least one basic capacitive plate and one compensation capacitive plate are independent form each other, and each of the basic and compensation capacitive plates has the metallic circuit connected to outside. The metallic circuits are outward connected to a switch, and such a switch can be a switch circuit manufactured in the product, or a switch structure provided in the product additionally. Such a switch is of conventional technique and will not be described in detail.

The second objective of the present invention is to provide a capacitor compensation method for a micro-electro-mechanical system which can efficiently compensate the condition of influencing the capacitance, improve the yield of good products and matching.

To achieve the objective of the present invention, one side of a micro-electro-mechanical capacitor includes at least one basic capacitive plate and one compensation capacitive plate. The above-mentioned basic capacitive plate and the compensation capacitive plate are independent from each other, and each of the basic and compensation capacitive plates has a metallic circuit connected to outside. Turning on and off the compensation capacitive plate can adjust and control the capacitance matching.

Thereby, according to the requirements, the present invention can turn on and off the compensation capacitive plate at any moment, so as to adjust the capacitance slightly, such that the problem of mismatching of the capacitor can be avoided and the difference between the products of different lots can be reduced.

In the above-mentioned capacitor compensation structure for a micro-electro-mechanical system, one side of the capacitor includes at least one basic capacitive plate and one compensation capacitive plate, and in the present invention, at least one compensation capacitive plate indicates a plurality of compensation capacitive plates. In addition, if the present invention comprises a plurality of compensation capacitive plates, the compensation capacitive plates are different in area from one another.

For example, when the present invention comprises one compensation capacitive plate, the area of such a compensation capacitive plate is A2, and the area of the basic capacitive plate is A1. At this moment, the capacitance satisfies the relations:

C=ε×A1/d or C=ε×(A1+A2)/d.

When the present invention is used to the suspension micro-electro-mechanical structure, residual stress will cause the varied distances, the capacitance satisfies the relations:

C=ε×A1/(d+D) or C=ε×(A1+A2)/d.

Thereby, according to the requirements, the present invention can turn on and off the compensation capacitive plate at any moment, so as to adjust the capacitance slightly, such that the problem of mismatching of the capacitor can be avoided and the difference between the products of different lots can be reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a conventional technology;

FIG. 2 is a cross sectional view of another conventional technology;

FIG. 3 is an illustrative view the warp of the structure of another conventional technology;

FIG. 4 is an illustrative view showing a capacitor compensation structure for a micro-electro-mechanical system in accordance with a first embodiment of the present invention;

FIG. 5 is an illustrative view showing the capacitor compensation structure for a micro-electro-mechanical system in accordance with a second embodiment of the present invention; and

FIG. 6 is an illustrative view showing the capacitor compensation structure for a micro-electro-mechanical system in accordance with a third embodiment of the present invention.

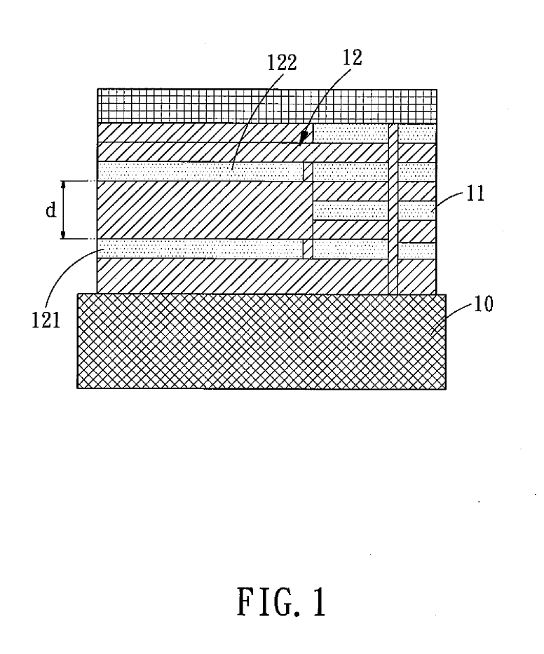

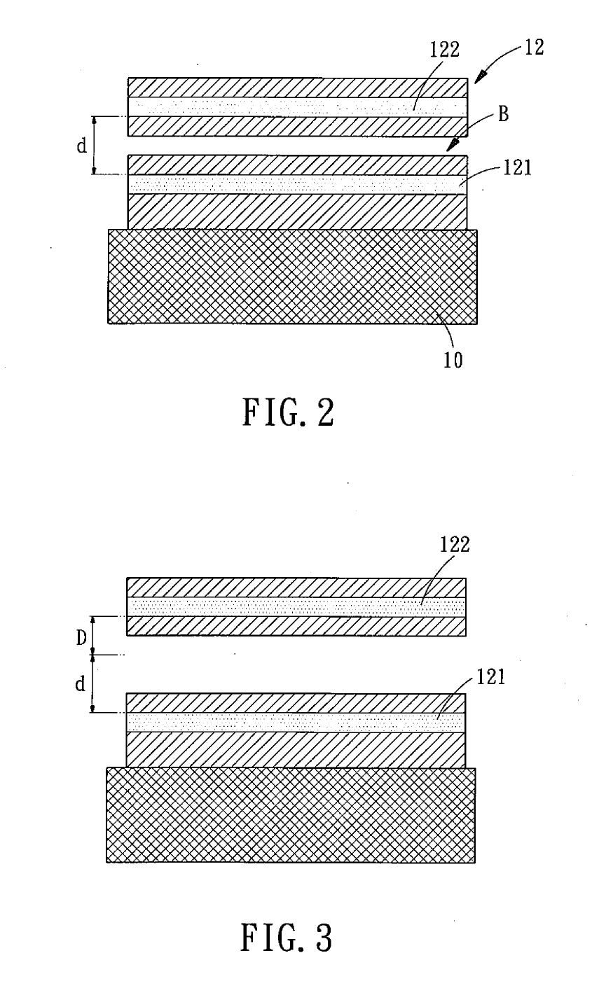

### DETAILED DESCRIPTION OF THE PREFERRED EMBODIMENTS

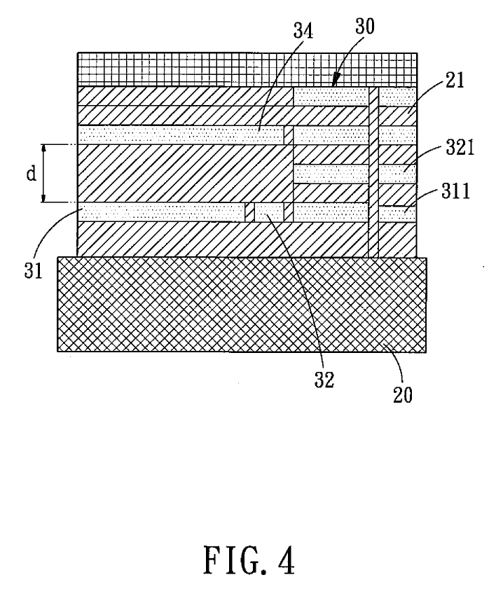

Referring to FIG. 4, a capacitor compensation structure for a micro-electro-mechanical system in accordance with a first embodiment of the present invention is formed in an insulating layer 21 located beside a silicon substrate 20. A capacitor 30 is deposited in the insulating layer 21 and comprises a first side basic capacitive plate 31 and a second side integrated capacitive plate 34. A distance d is formed between the basic capacitive plate 31 and the integrated capacitive plate 34. The present invention is characterized in that:

On the same layer of the basic capacitive plate 31 is formed at least one compensation capacitive plate 32, and the above-mentioned basic capacitive plate 31 and the compensation capacitive plate 32 are independent from each other. The area of the compensation capacitive plate 32 is A2, and the area of the basic capacitive plate 31 is A1. Each of the basic and compensation capacitive plates 31, 32 has a metallic circuit 311, 321 connected to outside. The metallic circuits 311, 321 are connected to a switch circuit (not shown) and can be outward or inward connected to a predetermined switch circuit (not shown) according to the conventional technology.

Thereby, during the testing process of the present invention, if the area A1 of the basic capacitive plate 31 is found to be unequal to the area A4 of the integrated capacitive plate 34, the switch circuit can be used to turn on or off the compensation capacitive plate 32 at any moment, and the following conditions will be produced:

Firstly, turning on the compensation capacitive plate 32 can effectively compensate the insufficient capacitance of the basic capacitive plate 31, and the capacitance satisfies the relation:

C=ε×(A1+A2)/d.

Secondly, closing the compensation capacitive plate 32 can maintain the original capacitance of the basic capacitive plate 31, and the capacitance satisfies the relation:

C=ε×A1/d.

Therefore, the present invention can efficiently avoid the problem of mismatching of the capacitor. Whether the area A1 of the basic capacitive plate 31 is unequal to the area A4 of the integrated capacitive plate 34, or the distance d is different, the capacitance can also be adjusted slightly, so as to efficiently reduce the difference between the products of different lots.

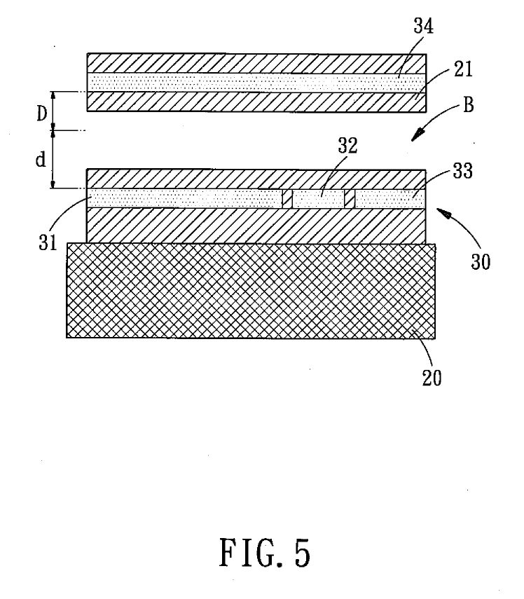

Referring to FIG. 5, a capacitor compensation structure for a micro-electro-mechanical system in accordance with a second embodiment of the present invention is applied to a micro suspension structure. Since an excessive inconsistency of the capacitance might occur under the warp condition, many compensation capacitive plates can be manufactured simultaneously according to different adjusting requirements, and the manufacturing method of the present embodiment is changed. The structure of the present embodiment is described as follows:

The capacitor compensation structure is also formed in the insulating layer 21 located beside the silicon substrate 20. The capacitor 30 is deposited in the insulating layer 21 and comprises the first side basic capacitive plate 31 and the second side integrated capacitive plate 34. The distance d is formed between the basic capacitive plate 31 and the integrated capacitive plate 34, and a suspension space B is formed between the basic capacitive plate 31 and the integrated capacitive plate 34 by using the etching technology. The present invention is characterized in that:

On the same layer of the basic capacitive plate 31 is formed two compensation capacitive plates 32, 33, and the above-mentioned basic capacitive plate 31 and the compensation capacitive plates 32, 33 are independent from one another. The areas of the compensation capacitive plates 32, 33 are A2, A3, and the area of the basic capacitive plate 31 is A1. The area A2 of the compensation capacitive plate 32 is different from the area A1 of the basic capacitive plate 31 and the area A3 of the compensation capacitive plate 33. Each of the basic and compensation capacitive plates 31, 32, 33 has a metallic circuit connected to outside (not shown). The metallic circuits are connected to a switch circuit (not shown) and can be outward or inward connected to a predetermined switch circuit (not shown) according to the conventional technology.

Thereby, during the testing process of the present invention, if a warping distance D is found to be formed after the integrated capacitive plate 34 is released by the suspension space B, or the area A1 of the basic capacitive plate 31 is unequal to the area A4 of the integrated capacitive plate 34, the switch circuit can be used to turn on or off the compensation capacitive plates 32, 33 at any moment, and the following conditions will be produced:

Firstly, turning on the compensation capacitive plate 32 can effectively compensate the small amount of insufficient capacitance formed by the original error, and the capacitance satisfies the relation:

C=ε×(A1+A2)/d.

Secondly, synchronously turning on the compensation capacitive plates 32, 33 can efficiently compensate the relatively large amount of insufficient capacitance of the space D caused by the warping problem, and the capacitance satisfies the relation:

C=ε×(A1+A2+A3)/(d+D).

Thirdly, synchronously closing the compensation capacitive plates 32, 33 can maintain the original capacitance, and the capacitance satisfies the relation:

C=ε×A1/d.

Therefore, the present invention can efficiently avoid the problem of mismatching of the capacitor when the micro suspension structure is warped. In addition, whether the area A1 of the basic capacitive plate 31 is unequal to the area A4 of the integrated capacitive plate 34, or the distance d is different, the capacitance can also be adjusted slightly, so as to efficiently reduce the difference between the products of different lots.

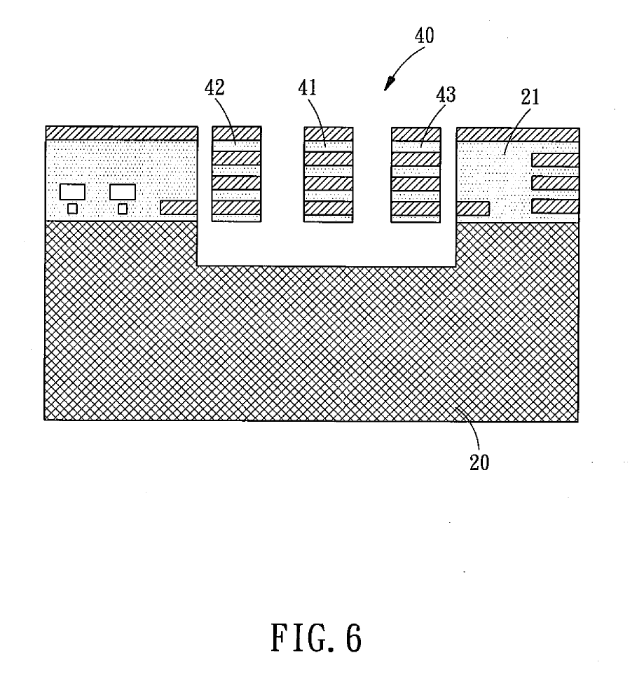

Referring to FIG. 6, a capacitor compensation structure for a micro-electro-mechanical system in accordance with a third embodiment of the present invention is also applied to the micro suspension structure. However, all the capacitor structures are manufactured to be the suspension structures, and a lateral configuration method is used to change the embodiment. The structure of the present embodiment is described as follows:

The capacitor compensation structure is also formed in the insulating layer 21 located beside the silicon substrate 20. A capacitor 40 is suspended in the insulating layer 21 and comprises a center basic capacitive plate 41 and an integrated capacitive plate 42, and the integrated capacitive plate 42 is located at one side of the basic capacitive plate 41. The distance d is formed between the basic capacitive plate 41 and the integrated capacitive plate 42. The present invention is characterized in that:

At the other side of the same layer of the basic capacitive plate 41 is suspended at least one compensation capacitive plate 43, and the above-mentioned basic capacitive plate 41 and the compensation capacitive plate 43 are independent from each other. Each of the compensation, integrated and basic capacitive plates 43, 42, 41 has a metallic circuit connected to outside (not shown). The above-mentioned metallic circuits are connected to a switch circuit (not shown) and can be outward or inward connected to a predetermined switch circuit (not shown) according to the conventional technology.

Thereby, during the testing process of the present invention, if the area of the integrated capacitive plate 42 is found to be unequal to that of the basic capacitive plate 41, or the capacitance is insufficient, the switch circuit can be used to turn on or off the compensation capacitive plate 43 at any moment, so as to effectively compensate the insufficient capacitance formed by the original error.

Therefore, the present invention can efficiently avoid the problem of mismatching of the capacitor when the micro suspension structure is warped. In addition, whether the areas are different or the capacitance is insufficient, the capacitance can also be adjusted slightly, so as to efficiently reduce the difference between the products of different lots.

The capacitor compensation method for a micro-electro-mechanical system is described as follows:

At least one compensation capacitive plate is formed beside a basic capacitive plate which is located at one side of a micro-electro-mechanical capacitor.

The above-mentioned basic capacitive plate and the compensation capacitive plate are independent from each other, and each of the basic and compensation capacitive plates has a metallic circuit connected to outside.

Turning on and off the compensation capacitive plate can adjust and control the capacitance matching.

Therefore, according to the requirements, the capacitor compensation method of the present invention can compensate the capacitive plates at any moment, so as to adjust the capacitance slightly, such that the problem of mismatching of the capacitor can be avoided and difference between the products of different lots can be reduced.

To summarize, the present invention is characterized in that: an insulating layer is formed on an upper surface of a silicon substrate, and a capacitor having at least one basic capacitive plate and one compensation capacitive plate is provided in the insulating layer. The above-mentioned basic capacitive plate and the compensation capacitive plate are independent from each other, each of the basic and compensation capacitive plates has a metallic circuit connected to outside, and the above-mentioned metallic circuits are connected to a switch.

Thereby, the present invention can efficiently avoid the problem of mismatching of the capacitor and can reduce the difference between the products of different lots.

While we have shown and described various embodiments in accordance with the present invention, it should be clear to those skilled in the art that further embodiments may be made without departing from the scope of the present invention.

What is claimed is:

1. A capacitor compensation structure for a micro-electro-mechanical system being formed in an insulating layer located beside a silicon substrate, a capacitor being deposited in the insulating layer and comprising a first side basic capacitive plate and a second side integrated capacitive plate, a distance being formed between the basic capacitive plate and the integrated capacitive plate, characterized in that:
on the same layer of the basic capacitive plate is formed at least one compensation capacitive plate, and the basic capacitive plate and the compensation capacitive plate are independent from each other.

2. The capacitor compensation structure for a micro-electro-mechanical system as claimed in claim 1, wherein an area of the compensation capacitive plate is different from that of the basic capacitive plate.

3. The capacitor compensation structure for a micro-electro-mechanical system as claimed in claim 2, wherein each of the basic and compensation capacitive plates has a metallic circuit connected to outside, and the metallic circuits are connected to a switch circuit.

4. The capacitor compensation structure for a micro-electro-mechanical system as claimed in claim 2, wherein each of the basic and compensation capacitive plates has the metallic circuit connected to outside, and the metallic circuits are connected to a switch.

5. A capacitor compensation method for a micro-electro-mechanical system, comprising:
forming at least one compensation capacitive plate beside a basic capacitive plate which is located at one side of a micro-electro-mechanical capacitor;
the basic capacitive plate and the compensation capacitive plate being independent from each other, each of the basic and compensation capacitive plate having a metallic circuit connected to outside; and
turning on and off the compensation capacitive plate to adjust and control a capacitance matching.

6. The capacitor compensation method for a micro-electro-mechanical system as claimed in claim 5, wherein a capacitive plate located at the other side of the micro-electro-mechanical capacitor is suspended.

7. A capacitor compensation structure for a micro-electro-mechanical system being formed in an insulating layer located beside a silicon substrate, a capacitor being deposited in the insulating layer and comprising a first side basic capacitive plate and a second side integrated capacitive plate, a distance being formed between the basic capacitive plate and the integrated capacitive plate, characterized in that:
on the same layer of the basic capacitive plate is formed at least one compensation capacitive plate, and the basic capacitive plate and the compensation capacitive plate are independent from each other.

8. The capacitor compensation structure for a micro-electro-mechanical system as claimed in claim 7, wherein an area of the compensation capacitive plate is different from that of the basic capacitive plate.

9. The capacitor compensation structure for a micro-electro-mechanical system as claimed in claim 8, wherein each of the basic and compensation capacitive plates has a metallic circuit connected to outside, and the metallic circuits are connected to a switch circuit.

10. The capacitor compensation structure for a micro-electro-mechanical system as claimed in claim 9, wherein each of the basic and compensation capacitive plates has the metallic circuit connected to outside, and the metallic circuits are connected to a switch.

11. The capacitor compensation structure for a micro-electro-mechanical system as claimed in claim 7, wherein a plurality of compensation capacitive plates is formed on the same layer of the basic capacitive plate, the basic capacitive plate and the compensation capacitive plates are independent from one another, each of the basic and compensation capacitive plates has a metallic circuit connected to outside, and the compensation capacitive plates are different in area from one another.

12. The capacitor compensation structure for a micro-electro-mechanical system as claimed in claim 7, wherein an etching process is performed between the compensation capacitive plate and the basic capacitive plate are to make one side of the capacitor suspended.

13. The capacitor compensation structure for a micro-electro-mechanical system as claimed in claim 7, wherein each of the basic and compensation capacitive plates has a metallic circuit connected to outside, and the metallic circuits are connected to a switch.
